(19) United States
(12) Patent Application Publication
(10) Pub. No.: US 2023/0122550 A1
(43) Pub. Date: Apr. 20, 2023

(54) DEHYDRATION APPARATUS FOR NATURAL GAS

(71) Applicant: Barry Holizki, Calgary (CA)

(72) Inventor: Barry Holizki, Calgary (CA)

(21) Appl. No.: 17/451,483

(22) Filed: Oct. 19, 2021

(51) Int. Cl. B01D 53/18; B01D 53/26; B01D 53/14; B01D 53/28; C10L 3/10

(52) U.S. Cl. CPC B01D 53/185; B01D 53/263; B01D 53/1493; B01D 53/28; C10L 3/106; C10L 2290/541

(57) ABSTRACT

A natural gas dehydration apparatus that is configured to provide dehydration of natural gas as the natural gas exits from a natural gas well. The apparatus of the present invention includes a vessel body having an interior volume. Disposed within the interior volume of the vessel body is a dehydrating fluid such as but not limited to methanol. The vessel body is oriented in an upright position and includes an inlet member operably coupled to the lower end thereof that provides introduction of natural gas into the vessel body. The inlet member includes an end section in the interior volume of the body and facilitates the introduction and percolation of natural gas through the methanol. A discharge pipe member directs the natural gas from the interior volume of the vessel body. A fill member provides introduction of additional methanol while a screen member controls methanol mist.

### FIELD OF THE INVENTION

The present invention relates generally to gas flow control and conditioning from natural gas wells, in particular but not by way of limitation, an apparatus configured to provide removal of water from a flow of natural gas running therethrough wherein the gas flow is most often at a lower pressure and/or flow rate. The present invention allows low pressure, low flow rate, emissions free natural gas wells to be operated year round through effective removal of water.

### BACKGROUND

There are thousands of natural gas wells that operate across North America. Low pressure and low flow rate raw natural gas flows from well sites and down stream processes. These lower flow rate natural gas wells are difficult to operate in colder climates due to the water content present in natural gas. The lower flow rates combined with the moisture content present results in the freezing of the well or components thereof blocking flow and as such causes the gas well to be inoperable. In the industry it is common for injection of materials such as methanol for hydrate prevention in natural gas. As is known in the art, the methanol combines with any free water or water vapor present in the natural gas, which results in the creation of an anti-freeze solution. The conventional method of executing the aforementioned is to utilize pneumatic injection pumps to introduce methanol into the gas stream.

One issue with the aforementioned conventional method is that the pneumatic injection pumps perform poorly at low supply pressures which results in either stalling of the pump, at low injection rates or pump over speed to keep the pump running, and over injection. This results in the requirement of routine diligent and continuous operator vigilance to ensure the pneumatic pump remains operational. Another issue with the conventional pneumatic pumps is that they are operated utilizing methane. During operation of the pneumatic pumps the methane is vented to the atmosphere. Venting of methane into the atmosphere has contributed to the accumulation of greenhouse gases which is suspected of contributing to climate change. Electrically operated injection pumps can be utilized in this application but these pumps have proven to be very costly to operate. Other dehydration methods involve glycol or desiccant system but these require greater gas flow rates to be economical and operate efficiently.

Accordingly, there is a need for a dehydration vessel for natural gas wherein the dehydration vessel provides optimum and efficient dehydration of natural gas for lower pressure and low flow rate gas wells without adversely affecting flow rates.

### SUMMARY OF THE INVENTION

It is the object of the present invention to provide a dehydration vessel for lower pressure and lower flow rate gas wells wherein the present invention includes a vessel having a body with an outer wall defining an interior volume.

Another object of the present invention is to provide an apparatus configured to be operably coupled to a low flow rate natural gas well so as to provide removal of water from the natural gas wherein the apparatus includes an inlet pipe member that is equipped with a valve.

A further object of the present invention is to provide a dehydration vessel for lower pressure and lower flow rate gas wells wherein the inlet pipe member is operably coupled to the vessel body utilizing a first technique and a second technique.

Still another object of the present invention is to provide an apparatus configured to be operably coupled to a low flow rate natural gas well so as to provide removal of water from the natural gas wherein the vessel body further has a fill pipe member proximate the upper end thereof.

An additional object of the present invention is to provide a dehydration vessel for lower pressure and lower flow rate gas wells wherein the vessel body includes a drain pipe member proximate the bottom of the vessel body.

Yet a further object of the present invention is to provide an apparatus configured to be operably coupled to a low flow rate natural gas well so as to provide removal of water from the natural gas wherein the interior volume of the vessel includes a screen member present near the upper end thereof.

Another object of the present invention is to provide a dehydration vessel for lower pressure and lower flow rate gas wells wherein the inlet pipe member in its second installation technique includes a bubbling member operably coupled proximate the end thereof disposed within the interior volume of the vessel body.

Still an additional object of the present invention is to provide an apparatus configured to be operably coupled to a low flow rate natural gas well so as to provide removal of water from the natural gas that further includes a discharge pipe member wherein the discharge pipe member is operable to direct natural gas from the interior volume of the vessel body towards a desired direction.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of a preferred embodiment of the present invention; and

FIG. 2 is a diagrammatic view of a preferred embodiment of the present invention illustrating the second installation technique for the inlet pipe member.

### DETAILED DESCRIPTION

Referring now to the drawings submitted herewith, wherein various elements depicted therein are not necessarily drawn to scale and wherein through the views and figures like elements are referenced with identical reference numerals, there is illustrated a gas dehydration apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the gas dehydration apparatus 100 includes a vessel body 10. The vessel body 10 includes an outer wall 12 wherein the outer wall 12 defines the interior volume 14 of the vessel body 10. The vessel body 10 is generally cylindrical in shape having a single outer wall 12. While the vessel body 10 is illustrated having a particular shape herein, it is contemplated within the scope of the present invention that the vessel body 10 could be provided in alternate shapes and sizes and further be formed from more than a single outer wall 12. The optimum size of the vessel body 10 is relative to the gas flow rate and good results have been achieved utilizing a vessel body 10 that is approximately three to five gallons in capacity. The vessel body 10 includes an upper end 16 and a lower end 17 and is oriented such that the vessel body 10 is in generally an upright position. This position of the vessel body 10 facilitates the percolation of the natural gas through the methanol 99 as will be further discussed herein.

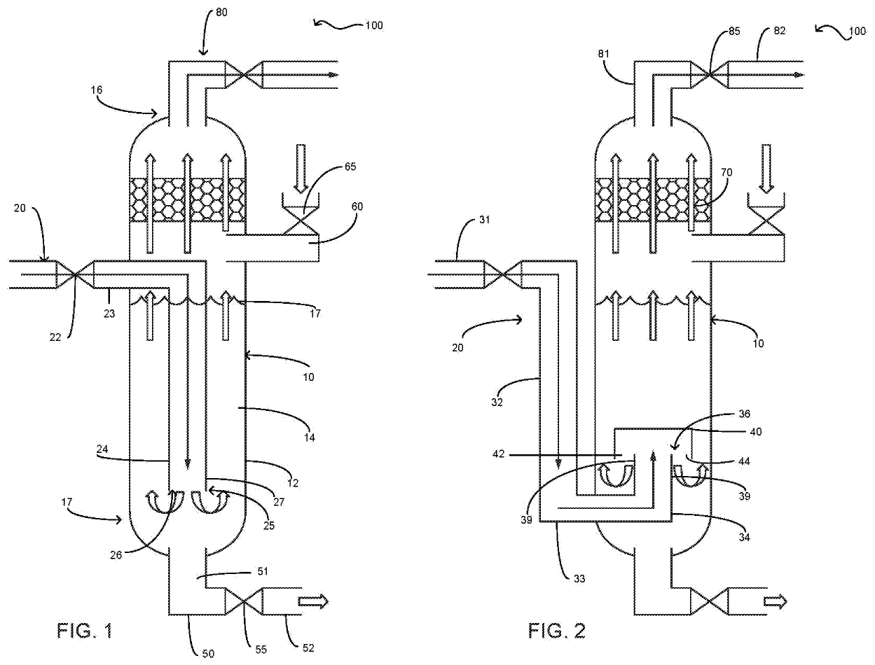

Operably coupled to the vessel body 10 is the inlet pipe member 20. The inlet pipe member 20 is a conventional metal pipe that is operably coupled to the vessel body 10 utilizing suitable durable techniques. The inlet pipe member 20 provides the input of natural gas from a natural gas well into the vessel body 10. The gas flow through the inlet pipe member 20 is operably controlled by valve 22. Valve 22 is a conventional flow control valve that is utilized to adjust the flow rate of natural gas into the interior volume 14 of the vessel body 10. As is illustrated herein the inlet pipe member 20 can be provided in alternate embodiments. Referring in particular to FIG. 1 the inlet pipe member 20 includes a first section 23 and second section 24 that are operably coupled. The first section 23 and second section 24 are perpendicularly oriented wherein the second section 24 includes end 25 that is disposed within the interior volume 14 of the vessel body 10 proximate the lower end 17 thereof. End 25 is includes an opening 26 and further includes a plurality of apertures 27 formed therein. As the gas flows through the inlet pipe member 20 to be discharged through end 25, the apertures 27 break up the gas flow and facilitate percolation through the methanol so as to improve dehydration of the gas.

Referring now in particular to FIG. 2, a second embodiment of the inlet pipe member 20 is illustrated therein. The second embodiment of the inlet pipe member 20 includes a first section 31, second section 32 that are exteriorly located with respect to the vessel body 10 and further being perpendicularly oriented with respect to each other. A third section 33 is contiguous with the second section 32 wherein the third section 33 is additionally contiguous and operably coupled to the fourth section 34 wherein the fourth section 34 is distally located from the second section 32 on the third section 33. The fourth section 34 is positioned to be upright and in general axial alignment with the vessel body 10 orientation. Superposed the end 36 of the fourth section 34 is bubbling member 40. The bubbling member 40 is constructed of a suitable material and is formed so as to divert gas flow to the first opening 42 and second opening 44 thereof. This arrangement is an alternative technique to assist in an improved introduction of natural gas into the vessel body 10 and provide percolation thereof through the methanol 99. The fourth section 34 additionally includes a plurality of apertures 39 formed therein similarly to the end 25 as discussed herein above. While two embodiments of the inlet pipe member 20 have been discussed and illustrated herein, it is contemplated within the scope of the present invention that the inlet pipe member 20 could be provided in alternate configurations to achieve the desired objective of introduction of natural gas flow into the interior volume 14 of the vessel body 10.

Proximate the lower end 17 of the vessel body 10 is drain pipe member 50. Drain pipe member 50 includes a first section 51 and a second section 52 wherein the first section 51 and second section 52 are contiguously formed and perpendicular with respect to each other. A valve 55 is present in the second section 52 of the drain pipe member 50 and is configured to provide control of release of the fluid disposed within the interior volume 14 when needed. It should be understood within the scope of the present invention that the drain pipe member 50 could be provided in alternate configurations and be able to achieve the desired objective of draining the interior volume 14 of the vessel body 10.

A fill pipe member 60 operably coupled to the vessel body 10 proximate the upper end 16. The fill pipe member 60 includes valve 65 and is operable to facilitate the introduction of a desired fluid such as but not limited to methanol 99 into the interior volume 14 of the vessel body 10. The fill pipe member 10 is utilized at installation and at maintenance intervals to provide introduction of methanol into the interior volume 14 so as to provide and/or maintain the methanol at a desired level to achieve dehydration of natural gas flowing therethrough. It should be understood within the scope of the present invention that the fill pipe member 60 could be provided in various alternate configurations in order to accomplish the desired function as discussed herein.

Screen member 70 is disposed within the interior volume 14 of the vessel body 10 proximate the upper end 16. The screen member 70 is located above the level of the methanol 99 and is manufactured from a suitable material such as but not limited to stainless steel. The screen member 70 is operable to eliminate methanol mist and any methanol from entering into the discharge pipe member 80. It should be understood within the scope of the present invention that the screen member 70 could be provided in alternate sizes and materials in order to accomplish the desired objective discussed herein.

A discharge pipe member 80 is operably coupled to the upper end 16 of the vessel body 10. The discharge pipe member 80 is operable to provide discharge of dehydrated natural gas from the interior volume 14 of the vessel body 10. The discharge pipe member 80 includes a first section 81 and a second section 82 that are contiguously formed and perpendicular in orientation with respect to each other. A valve 85 is present in the second section wherein the valve 85 is a conventional flow valve that is operable to provide adjustment of the flow rate of natural gas exiting the gas dehydration apparatus 100. It should be understood that alternate types of valves could be utilized. Additionally, it is further contemplated within the scope of the present invention that the discharge pipe member 80 could be provided in alternate configurations in order to achieve the desired objective discussed herein. While the gas dehydration apparatus 100 could be installed at various locations of a natural gas flow, it is preferred within the scope of the present invention that the gas dehydration apparatus 100 is installed just downstream of the last valve of the natural gas well head. This allows to maximize flow rate at the natural gas well head.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A natural gas dehydration apparatus comprising:
a vessel body, said vessel body having at least one outer wall, said at least one outer wall defining a shape of said vessel body, said vessel body having an interior volume, said vessel body having an upper end and a lower end, said vessel body being oriented such that the upper end and lower end are in axial alignment;
an inlet pipe member, said inlet pipe member being operably coupled to a natural gas source, said inlet pipe member being operably coupled to the interior volume of said vessel body, said inlet pipe member configured to introduce natural gas into said interior volume of said vessel body;
a discharge pipe member, said discharge pipe member being operably coupled to said upper end of said vessel body, said discharge pipe member being operable to discharge natural gas from said interior volume of said vessel body; and
a volume of dehydrating fluid, said volume of dehydrating fluid being disposed within said interior volume of said vessel body, wherein said dehydrating fluid has the natural gas introduced thereinto prior to being discharged from the vessel body through said discharge pipe member.

2. The natural gas dehydration apparatus as recited in claim 1, and further including a fill pipe member, said fill pipe member configured to introduce said dehydrating fluid into said interior volume of said vessel body, said fill pipe member being proximate said upper end of said vessel body.

3. The natural gas dehydration apparatus as recited in claim 2, and further including a drain pipe member, said drain pipe member being proximate said lower end of said vessel body, said drain pipe member further including a valve, said drain pipe member operable to evacuate the dehydrating fluid from said interior volume of said vessel body.

4. The natural gas dehydration apparatus as recited in claim 3, wherein said inlet pipe member further includes at least two sections, said at least two sections having a portion thereof disposed within the dehydrating fluid, said portion of said at least two sections having an end wherein the end includes a plurality of apertures configured to disperse gas flow into the dehydrating fluid.

5. The natural gas dehydration apparatus as recited in claim 4, and further including a screen member, said screen member being disposed within said interior volume of said vessel body, said screen member being located above said volume of dehydrating fluid, wherein said screen member is configured to eliminate a mist of the dehydrating fluid.

6. The natural gas dehydration apparatus as recited in claim 4, wherein said inlet pipe member further includes a cap member, said cap member being proximate the portion of said at least two sections of said inlet pipe member, said cap member creating a first opening and a second opening on opposing sides thereof.

7. The natural gas dehydration apparatus as recited in claim 6, wherein said discharge pipe member further includes a valve, said valve operable to adjust a natural gas flow exiting from said vessel body.

8. The natural gas dehydration apparatus as recited in claim 7, wherein said inlet pipe member further includes a valve, said valve of said inlet pipe member being configured to control a flow rate of natural gas into said vessel body.

9. The natural gas dehydration apparatus as recited in claim 8, wherein said vessel body is provided in a size ranging from three gallons to five gallons in fluid capacity or a size relative to a flow rate of gas.

10. A natural gas dehydration apparatus operably coupled to a natural gas flow so as to dehydrate natural gas being discharged from the natural gas flow wherein the natural gas dehydration apparatus comprises:
a vessel body, said vessel body having an outer wall, said outer wall defining a shape of said vessel body, wherein said vessel body is generally cylindrical in shape, said vessel body having an interior volume, said vessel body having an upper end and a lower end, said vessel body being oriented such that the upper end and lower end are in axial vertical alignment;
a dehydrating fluid, said dehydrating fluid being disposed in a portion of said interior volume of said vessel body, said dehydrating fluid operable to remove water from natural gas passing therethrough;
an inlet pipe member, said inlet pipe member being operably coupled to a natural gas source, said inlet pipe member being operably coupled to the interior volume of said vessel body, said inlet pipe member having a portion thereof disposed in said dehydrating fluid, said portion of said inlet pipe member disposed in the dehydrating fluid having an end, said end having an opening providing introduction of natural gas into the dehydrating fluid;
a discharge pipe member, said discharge pipe member being operably coupled to said upper end of said vessel body, said discharge pipe member being operable to discharge natural gas from said interior volume of said vessel body; and
a fill pipe member, said fill pipe member configured to introduce the dehydrating fluid into said interior volume of said vessel body, said fill pipe member being proximate said upper end of said vessel body, said fill pipe member further including a valve.

11. The natural gas dehydration apparatus as recited in claim 10, wherein said inlet pipe member has a first configuration and a second configuration, wherein the first configuration the end of the portion of the inlet pipe member disposed in the dehydrating fluid is oriented such that the end is towards the lower end of said vessel body.

12. The natural gas dehydration apparatus as recited in claim 11, wherein in the second configuration the end of the portion of the inlet pipe member disposed in the dehydrating fluid is oriented such that the end is towards the upper end of said vessel body.

13. The natural gas dehydration apparatus as recited in claim 12, wherein in the second configuration of the inlet pipe member a cap member is located proximate the end of the portion of the inlet pipe member disposed in the dehydrating fluid, wherein the cap member has openings on opposing sides thereof.

14. The natural gas dehydration apparatus as recited in claim 13, wherein the cap member is configured to divert natural gas into the dehydrating fluid through the openings on opposing sides of the cap member.

15. The natural gas dehydration apparatus as recited in claim 14, wherein the end of the portion of the inlet pipe member in the first configuration thereof disposed in the dehydrating fluid includes apertures operable to disperse natural gas into the dehydrating fluid.

16. The natural gas dehydration apparatus as recited in claim 15, and further including a screen member, said screen member being disposed within said interior volume of said vessel body, said screen member being located above said volume of dehydrating fluid, wherein said screen member is configured to eliminate a mist of the dehydrating fluid.

17. The natural gas dehydration apparatus as recited in claim 11, wherein the end of the portion of the inlet pipe member in the second configuration thereof disposed in the dehydrating fluid includes apertures operable to disperse natural gas into the dehydrating fluid.

18. The natural gas dehydration apparatus as recited in claim 17, wherein said discharge pipe member further includes a valve, said valve operable to adjust a natural gas flow exiting from said vessel body.

19. The natural gas dehydration apparatus as recited in claim 18, wherein the dehydrating fluid is methanol.

20. The natural gas dehydration apparatus as recited in claim 19, wherein said vessel body is provided in a size ranging from three gallons to five gallons in fluid capacity or as related to a gas flow rate of the natural gas flow.
